(19) United States
(12) Patent Application Publication
(10) Pub. No.: US 2017/0170599 A1
(43) Pub. Date: Jun. 15, 2017

(54) CONNECTOR

(71) Applicant: Sumitomo Wiring Systems, Ltd., Yokkaichi (JP)

(72) Inventors: Tianyu Zhou, Yokkaichi (JP); Yujiro Imai, Yokkaichi (JP)

(21) Appl. No.: 15/362,922

(22) Filed: Nov. 29, 2016

(30) Foreign Application Priority Data
Dec. 11, 2015 (JP) 2015-241920

(51) Int. Cl. H01R 13/533; H01R 13/52; H01R 13/11; H01R 13/627; H01R 13/58; H01R 24/20

(52) U.S. Cl. CPC H01R 13/533; H01R 13/5812; H01R 24/20; H01R 13/11; H01R 13/6273; H01R 13/5205; H01R 2103/00

(57) ABSTRACT

A connector includes a housing (10) with cavities (11) into which terminal fittings (T) connected to end parts of wires (W) are to be accommodated from behind. A wire holding assembly (30) is to be mounted to a rear part of the housing (10) and includes vibration limiting portions (31) configured to limit the vibration of the wires in the cavities (11) by entering the cavities (11) from behind. A wall (36) extends along an outer surface of the housing (10). Locks (23, 44) are provided on the outer surface of the housing (10) and in the wall (36) and lockable to each other in a front-back direction. An inclination preventing portion (47) projects forward from the wall (36) and extends along the outer surface of the housing (10).

### BACKGROUND

1. Field of the Invention

The present invention relates to a connector.

2. Description of the Related Art

Japanese Unexamined Patent Publication No. 2006-73429 discloses a connector that has a housing formed with a cavity. A terminal fitting is connected to an end part of a wire and is accommodated in the cavity of the housing. A wire holding assembly is mounted to a rear part of the housing and holds the wire so that vibration of the wire does not apply a harmful force to the terminal fitting. The wire holding assembly includes a substantially cylindrical portion that is fit externally to a wire and pushed into a cavity of the housing. The cylindrical portion restricts vibration of the wire in the cavity and prevents vibration of the terminal fitting even if the wire vibrates with respect to the connector. A locking piece is cantilevered forward from the wire holding assembly and engages a projection on an outer surface of the housing to prevent backward detachment of the wire holding assembly.

However, in the configuration described above, violent vibration of the wire could cause the wire holding assembly to incline and could separate the locking piece from the outer surface of the housing. Eventually, the wire holding assembly may be detached. Thus, a connector with higher vibration resistance has been desired to ensure that vibration does not apply a harmful force to a terminal fitting and does not wear the terminal fitting even under a stricter vibration condition.

The invention was completed based on the above situation and aims to enhance vibration resistance.

### SUMMARY

The invention relates to a connector that has a housing with at least one cavity. A terminal fitting connected to a wire can be inserted into the cavity in a terminal insertion direction. A wire holding assembly is to be mounted to the housing and includes at least one vibration limiting portion configured to limit vibration of the wire in the cavity by entering the cavity in the terminal insertion direction. The wire holding assembly further has a wall extending along an outer surface of the housing. One or more locks are provided on the outer surface of the housing and in the wall. The locks are lockable to each other in a front-back direction. At least one inclination preventing portion projects substantially forward from the wall and extends along the outer surface of the housing.

The inclination preventing portion may include at least one backlash preventing protrusion configured to come into contact with the outer surface of the housing to prevent backlash of the wire holding assembly.

One or more standing walls may be configured to engage the wire laterally when the wire holding assembly is mounted to the housing.

At least one pressing portion may be provided in a rear end of the wire holding assembly and may be configured to press the wire. Thus, wear of the terminal fitting can be suppressed by directly fixing the wire to the terminal fitting against the vibration of the wire.

The pressing portion may be provided between two standing walls, and a projecting end of the pressing portion may be located below distal ends of the standing wall portions. The pressing portion may have a chevron shape so that an intermediate part in the front-back direction is highest. A projecting end of the pressing portion may be a substantially horizontal flat surface.

A window may be provided in a rear end part of the wire holding assembly and may be open in the front-back direction.

A rear surface of one lock may define a locking surface to be locked to the other lock and/or a front surface of one lock may be formed into a guiding surface for guiding a locking operation to the other lock.

As described above, the contact of the inclination preventing portion with the outer surface of the housing prevents the wire holding assembly from being inclined in an unlocking direction of the locks (direction in which the wall is separated from the outer surface of the housing). Thus, vibration resistance can be further enhanced.

These and other features and advantages of the invention will become more apparent upon reading the following detailed description of preferred embodiments and accompanying drawings. It should be understood that even though embodiments are described separately, single features may be combined to additional embodiments.

### BRIEF DESCRIPTION OF THE DRAWINGS

FIG. 1 is a perspective view of a connector in an embodiment.

FIG. 2 is a section showing the connector.

FIG. 3 is a side view showing the connector.

FIG. 4 is a rear view showing the connector.

FIG. 5 is a rear view of a housing.

FIG. 6 is a partial enlarged bottom view showing a rear part of the housing.

FIG. 7 is a perspective view showing a wire holding assembly.

FIG. 8 is a front view showing the wire holding assembly.

FIG. 9 is a side view showing the wire holding assembly.

FIG. 10 is a rear view showing the wire holding assembly.

FIG. 11 is a plan view showing the wire holding assembly.

### DETAILED DESCRIPTION

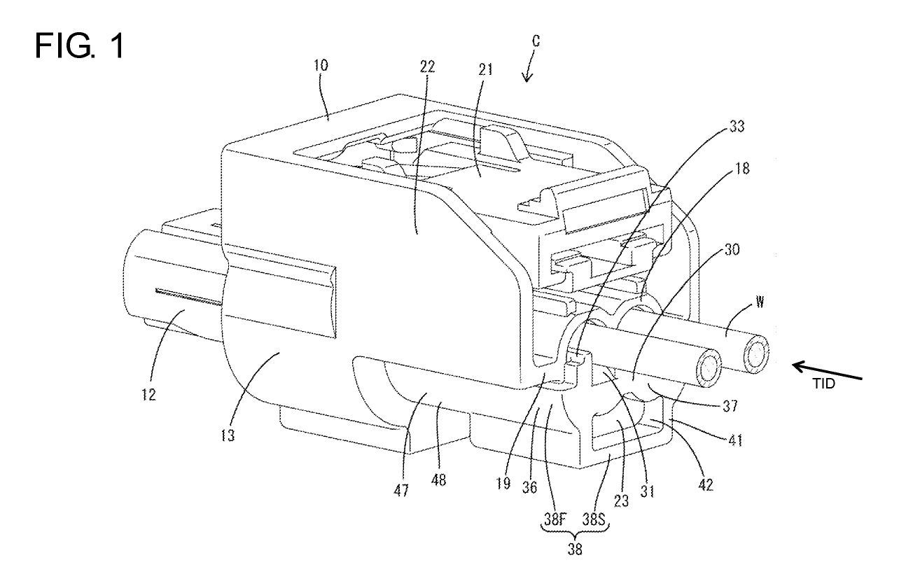

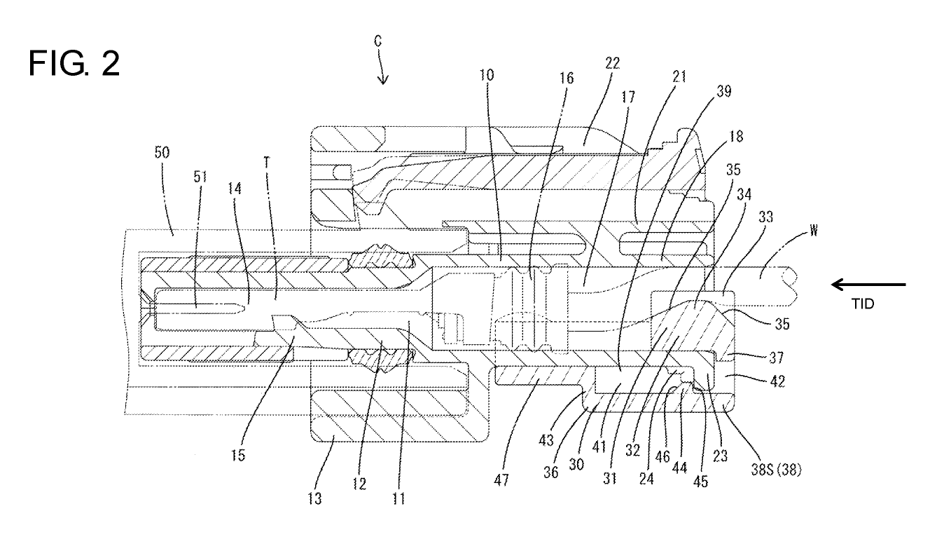

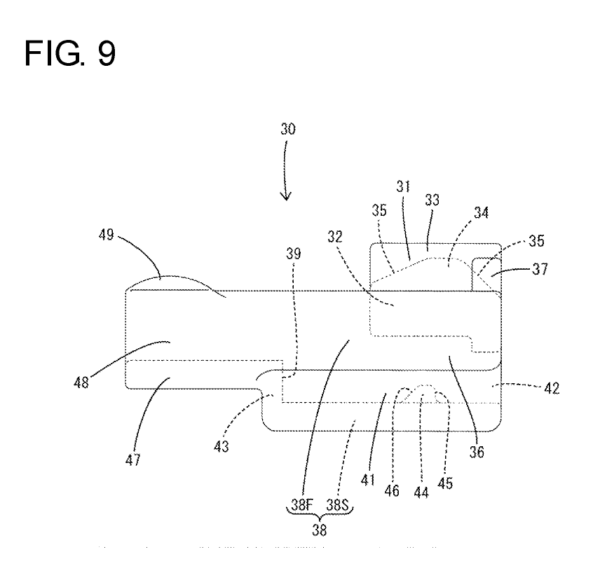

One specific embodiment of the invention is described herein with reference to FIGS. 1 to 11. A connector C in this embodiment includes a housing 10 in which terminal fittings T connected to end parts of wires W are to be accommodated, and a wire holding assembly 30 to be mounted to a rear part of the housing 10. In the following description, in each constituent member, a left side in FIG. 2 (connection surface side of the connector C to a mating connector 50) is referred to as a front end, a right side (toward which the wires W are pulled out) is referred to as a rear end, an upper side is referred to as an upper side and a lower side is referred to as a lower side.

The housing 10 is made e.g. of synthetic resin and includes a housing body 12 formed with cavities 11 into which the terminal fittings T are to be accommodated, and an outer wall 13 surrounds the housing body 12.

The outer wall 13 surrounds an intermediate part of the housing body 12 in a terminal inserting direction TID and is open forward. A space between the housing body 12 and the outer wall 13 defines a connection space into which the mating connector 50 is fittable.

The housing body 12 is provided with cavities 11. Each cavity 11 is open backward and the terminal fitting T is insertable therein in the terminal inserting direction TID from behind. The cavities 11 are arranged side by side in a lateral direction (width direction).

A substantially front half of each cavity 11 defines a terminal accommodating portion 14 into which the terminal fitting T is to be accommodated, as shown in FIG. 2. A locking lance 15 is provided in the terminal accommodating portion 14 for locking and retaining the terminal fitting T.

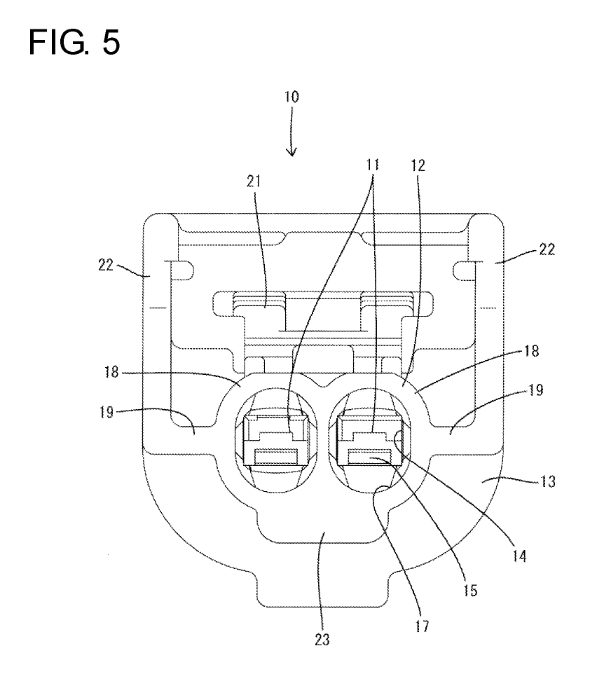

A rear portion of each cavity 11 defines a seal accommodating portion 17 with a circular cross-sectional shape, and a seal 16 fit on the wire W can be held in close contact therewith. As shown in FIG. 5, the seal accommodating portion 17 is slightly longer in a vertical direction and has a larger opening than the terminal accommodating portion 14.

A rear part of the housing body 12 (part behind the outer wall 13) defines tubular portions 18 in the form of hollow cylinders in conformity with the shape of the seal accommodating portions 17, as shown in FIG. 5. Two of the tubular portions 18 are provided in the width direction to correspond to the seal accommodating portions 17. The tubular portions 18 are arranged side by side in the lateral direction and are coupled integrally or unitarily in a central or intermediate part in an arrangement direction.

Projecting walls 19 are provided on opposite widthwise sides of the housing body 12 and project in the lateral direction. The projecting wall 19 projects in a horizontal direction from a vertical central part of the tubular portion 18. The projecting wall 19 extends substantially over the entire length of the tubular portion 18 in a front-back direction.

A lock arm 21 for locking the mating connector 50 in a properly connected state is provided on the upper surface of the housing body 12. Protection walls 22 standing up from the projecting ends of the projecting wall portions 19 at opposite left and right sides of the lock arm 21.

A first lock 23 is provided at the lower surface of the housing body 12 for holding the wire holding assembly 30 in a mounted state.

The terminal fitting T is formed by bending a conductive metal plate material and is long and narrow in the front-back direction. The terminal fitting T is connectable to a mating terminal fitting 51 provided in the mating connector 50. A rear end part of the terminal fitting T is crimped and connected to the end part of the wire W and a seal 16. The seal 16 is made of rubber such as silicon rubber and has a hollow cylindrical shape long in the front-back direction.

The wire holding assembly 30 is made e.g. of synthetic resin and is molded separately from the housing 10. As shown in FIG. 2, the wire holding assembly 30 includes vibration limiting portions 31 that enter the cavities 11 and limit vibration of the wires W in the cavities 11.

The vibration limiting portion 31 enters the cavity 11 from behind and in the terminal insertion direction TID from behind. The vibration limiting portion 31 is provided to individually correspond to each cavity 11. Two juxtaposed vibration limiting portions 31 are coupled to each other in rear end parts. The rear end part (coupled part) of each vibration limiting portion 31 projects back from the cavity 11 when the wire holding assembly 30 is mounted to the housing 10.

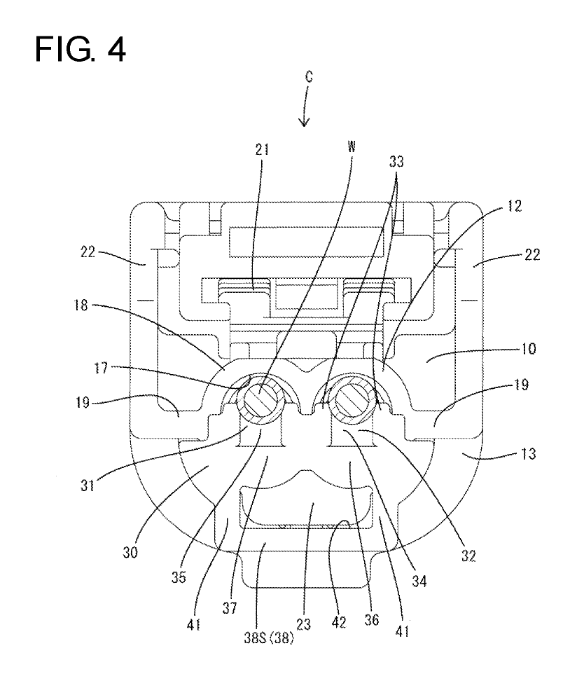

Each vibration limiting portion 31 includes an inrush portion 32 to be accommodated into a lower part of each cavity 11. Each inrush portion 32 has an outer shape in conformity with the surface of the seal accommodating portion 17. Each vibration limiting portion 31 further includes two standing walls 33 standing on both left and right sides of the inrush portion 32. The standing walls 33 stand on the upper surface of the inrush portion 32 and are adjacent to the wire W at opposite left and right sides of the wire W when the wire holding assembly 30 is mounted to the housing 10 (see FIG. 4).

Each vibration limiting portion 31 has a pressing portion 34 projecting on the upper surface of the inrush portion 32. The pressing portion 34 is between the standing walls 33 and has a chevron shape so that an intermediate part in the front-back direction is highest. A projecting end of the pressing portion 34 is a substantially horizontal flat surface and is below the upper ends of the standing walls 33. Inclined surfaces 34 are formed on front and rear ends of the projecting end of the pressing portion 34 and are inclined down to the front and back (inclined with respect to the terminal insertion direction TID). The front inclined surface 35 is inclined more moderately than the rear inclined surface 35 (see FIG. 2).

The wire holding assembly 30 includes a wall 36 extending along the outer surface of the housing 10. The wall 36 covers the rear part of the housing body 12 from below (or from a direction intersecting the terminal insertion direction TID). The wall portion 36 includes a rear wall 37 for covering the rear ends of the tubular portions 18 and a side wall 38 for covering outer peripheral sides of the tubular portions 18 and is box-shaped as a whole.

The rear wall 37 is coupled to rear parts of the vibration limiting portions 31. The rear wall 37 covers lower parts of the rear ends of the tubular portions 18 when the wire holding assembly is mounted to the housing 10 (see FIG. 4).

The side wall 38 is for covering a lower surface side of the housing body 12. As shown in FIG. 1, the side wall 38 includes first side walls 38F that are curved along the outer peripheral surfaces of the tubular portions 18 and a second side wall 38S that is a substantially flat horizontal plate.

The first side walls 38F are provided on opposite widthwise sides of the wire holding assembly 30 and cover parts of the tubular portions 18 below the projecting walls 19. The first side walls 38F are substantially parallel to the outer peripheral surfaces of the inrush portions 32 of the vibration limiting portions 31. The tubular portions 18 are inserted into between the inrush portions 32 of the vibration limiting portions 31 and the first side walls 38F.

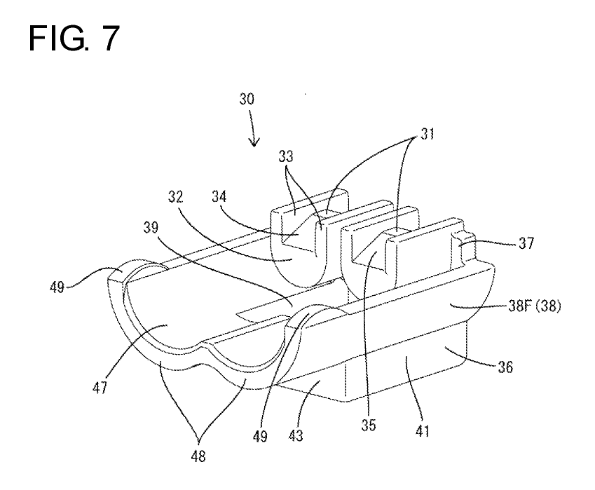

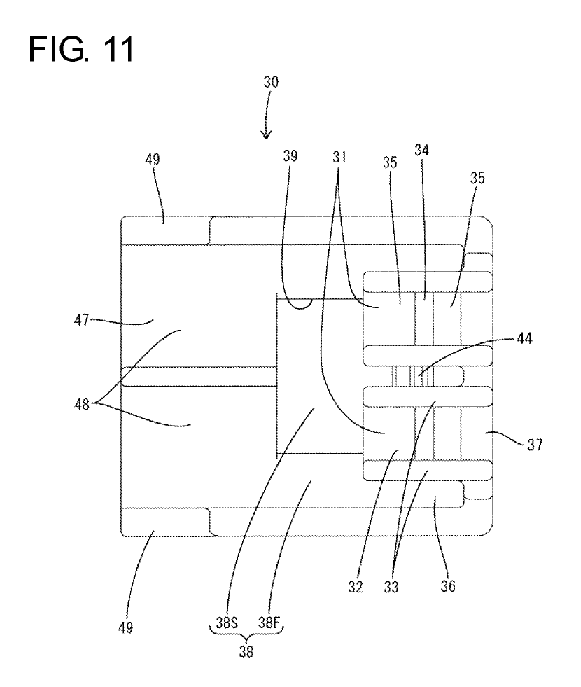

A substantially square vertically extending opening 39 is formed between the first side walls 38F (see FIGS. 7 and 11). The opening 39 is in a part above the second side wall 38S and a part below the vibration limiting portions 31.

The second side wall 38S faces the first lock 23 in the vertical direction when the wire holding assembly 30 is mounted to the housing 10. The second side wall 38S is spaced from the lower surface of the housing body 12 by a height of the first lock 23 and arranged along the lower projecting end of the first lock 23.

The second side wall 38S has a substantially square shape when viewed from below. A dimension of the second side wall 38S in the lateral direction is smaller than that of the first side walls 38F in the lateral direction so that the first side walls 38F project at both left and right sides of the second side wall 38S.

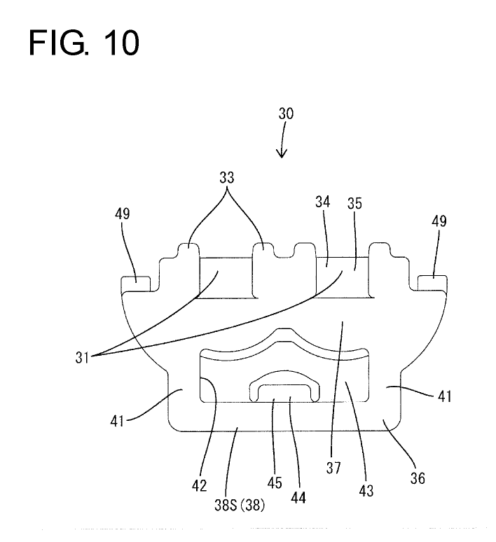

As shown in FIG. 10, the second side wall 38S is coupled to the first side walls 38F by coupling walls 41 provided on both left and right sides. The coupling walls 41 are substantially perpendicular to the second side wall 38S.

A window 42 is provided in a rear end part of the wire holding assembly 30 and is open in the front-back direction. As shown in FIG. 10, the window 42 is surrounded by the second side wall 38S, the coupling walls 41 and the rear wall 37. The window 42 has a width equal to that of the first lock 23 in the housing 10 (see FIG. 4).

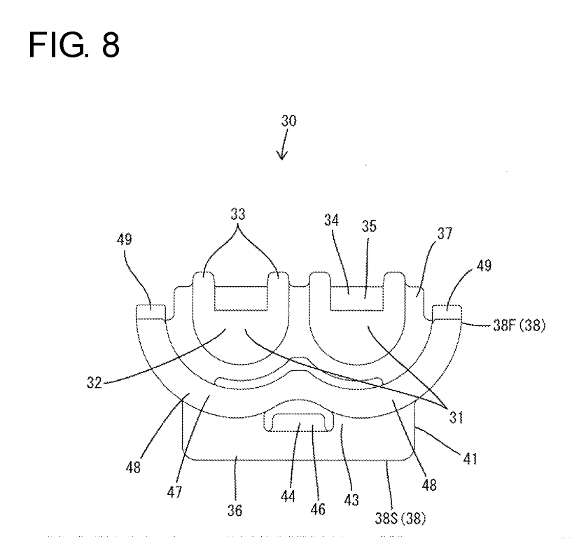

A front wall 43 is provided on the front end of the second side wall 38S and is continuous with the coupling walls 41 and the first side walls 38F. A part of the front wall 43 corresponding to a second lock 44 to be described later is open (see FIG. 8).

The wire holding assembly 30 and the housing 10 are provided with the first and second locks 23, 44 that are lockable to each other in the front-back direction or the terminal insertion direction TID.

As shown in FIG. 2, the first lock 23 projects on the lower surface of the housing 10 and hangs down along the rear end edge of the housing body 12. Both front and rear surfaces of the first lock 23 are substantially transverse to the front-back direction or the terminal insertion direction TID. As shown in FIG. 5, the first lock 23 is provided in a widthwise central part of the housing body 12 and is a wide long wall crossing over the adjacent tubular portions 18.

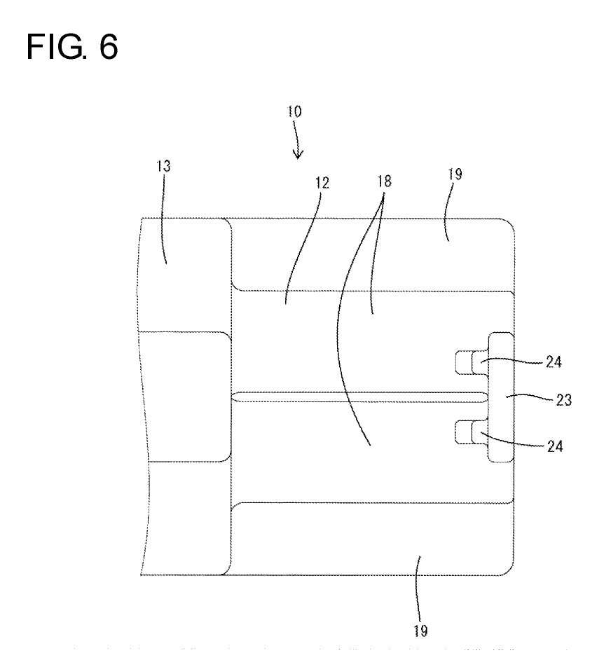

As shown in FIG. 6, left and right ribs 24 project on the lower surface of the housing body 12 and are in front of the first lock 23. The ribs 24 are integrated with the front surface of the first lock 23 and the lower surface of the housing body 12. As shown in FIG. 2, sides of the ribs 24 near the first lock 23 (rear sides) project slightly down and have a stepped shape.

As shown in FIG. 10, the second lock 44 projects on the upper surface of the second side wall 38S. The second lock 44 has a laterally long shape whose projecting dimension is smaller than a width. Note that the width of the second lock 44 is equivalent to an interval between the ribs 24.

As shown in FIG. 2, the rear of the second lock 44 is formed into a locking surface 45 to be locked to the first lock 23. The locking surface 45 is substantially perpendicular to the second side wall 38S (substantially transverse to the front-back direction or the terminal insertion direction TID). The locking surface 45 of the second lock 44 can come into contact with a part of the front surface of the first lock 23 below the ribs 24.

As shown in FIG. 2, the front of the second lock 44 is formed into a guiding surface 46 for guiding a locking operation to the first lock 23. The guiding surface 46 is inclined gradually up toward the back.

As shown in FIG. 2, the wire holding assembly 30 includes an inclination preventing portion 47 projecting forward from the wall 36 and extending along the outer surface of the housing 10. As shown in FIG. 7, the inclination preventing portion 47 is curved along the lower surface of the housing 10 and projects forward from the first side walls 38F. With the wire holding assembly 30 mounted to the housing 10, the front end of the inclination preventing portion 47 is located near the outer wall 13 as shown in FIG. 2. Specifically, the lower surfaces of the tubular portions 18 are covered substantially entirely by the wall 36 and the inclination preventing portion 47.

As shown in FIG. 7, the inclination preventing portion 47 is continuous in the lateral direction in front of the opening 39. The inclination preventing portion 47 has curves 48 shaped in conformity with the tubular portions 18. The curves 48 have a cross-sectional shape similar to that of the first side walls 38F and are connected in front of the first side wall 38F.

A widthwise intermediate of the inclination preventing portion 47 is raised up between the curves 48. Note that the central part of the inclination preventing portion 47 is located below opposite widthwise end parts.

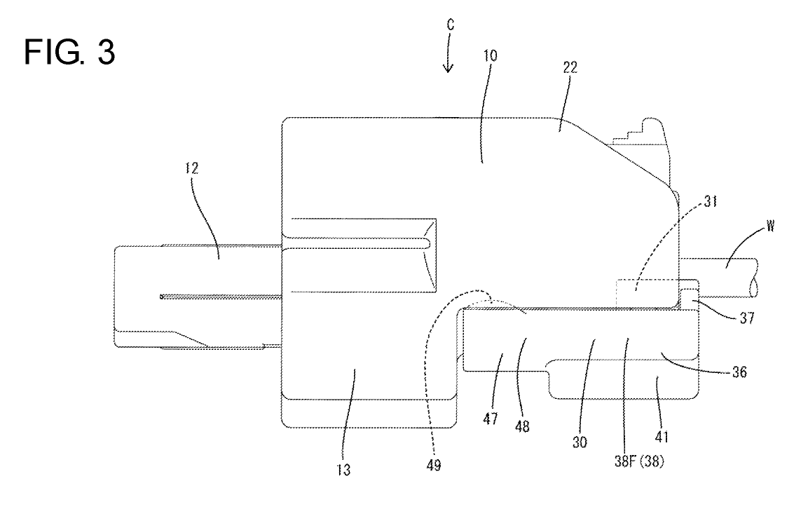

As shown in FIG. 3, the inclination preventing portion 47 includes backlash preventing protrusions 49 configured to come into contact with the outer surface of the housing 10 when the wire holding assembly 30 is mounted to the housing 10. As shown in FIG. 7, the backlash preventing protrusions 49 project on the upper surface of the inclination preventing portion 47. The backlash preventing protrusions 49 are provided on a front end part and both left and right end parts of the inclination preventing portion 47. The upper projecting surfaces of the backlash preventing protrusions 49 have moderately arcuately curves.

Next, an example of an assembling procedure of the connector C of this embodiment is described.

First, the terminal fittings T are accommodated into the housing 10. The terminal fitting T secured to the end part of the wire W is accommodated into each cavity 11 from behind and in the terminal insertion direction TID. The terminal fitting T inserted to a proper position in each cavity 11 is retained and held by the locking lance 15.

Subsequently, the wire holding assembly 30 is mounted. The wire holding assembly 30 is arranged at such a position that the vibration limiting portions 31 are retracted back from the cavities 11. At this time, the second lock 44 is arranged to face the first lock 23 from behind and in the terminal insertion direction TID. Further, the inclination preventing portion 47 is in contact with the lower surface of the housing body 12 (on a side in front of the first lock 23).

The vibration limiting portions 31 are inserted respectively into the corresponding cavities 11 when the wire holding assembly 30 is pushed forward in the terminal insertion direction TID and the inclination preventing portion 47 moves forward along the lower surface of the housing body 12. Further, the guiding surface 46 of the second lock 44 contacts the first lock 23, the second lock 44 moves over the first lock 23 by the inclination of the guiding surface 46 and the second and first locks 44, 23 are locked to each other in the front-back direction. In this state, as shown in FIG. 4, the first lock 23 can seen substantially entirely through the window 42 of the wire holding assembly 30 so that proper mounting of the wire holding assembly 30 to the housing 10 can be confirmed.

The assembling operation of the connector C is completed in the above way.

With the wire holding assembly 30 mounted to the housing 10, the pressing portion 34 of the vibration limiting portion 31 inserted in each cavity 11 resiliently bites into the insulation coating of the wire W and, as shown in FIG. 2, the wire W is pressed against the upper wall surface of the cavity 11 to limit vibration in the vertical and lateral directions. Further, the wire W is sandwiched by the left and right standing walls 33 of the vibration limiting portion 31 to limit vibration in the lateral direction. The backlash preventing protrusions 49 are in contact with the lower surfaces of the projecting walls 19 to prevent the backlash of the wire holding assembly 30 in the vertical direction.

Further, with the wire holding assembly 30 mounted to the housing 10, the entire wire holding assembly 30 (entire inclination preventing portion 47 and wall portion 36) is accommodated behind the outer wall portion 13 without projecting outward from the outer wall portion 13 as shown in FIG. 3. In this way, the enlargement of the connector C is prevented.

Next, functions and effects of the embodiment configured as described above are described.

The connector C of this embodiment includes the housing 10 provided with the cavities 11 into which the terminal fittings T connected to the end parts of the wires W are to be accommodated from behind and in the terminal insertion direction TID, and the wire holding assembly 30 to be mounted to the rear part of the housing 10. The wire holding assembly 30 includes the vibration limiting portions 31 for limiting the vibration of the wires W in the cavities 11 by entering the cavities 11 from behind and the wall 36 extending along the outer surface of the housing 10. The locks 23, 44 are provided on the outer surface of the housing 10 and in the wire holding assembly 30 and lockable to each other in the front-back direction. The wire holding assembly 30 includes the inclination preventing portion 47 projecting forward from the wall portion 36 and extending along the outer surface of the housing 10.

According to this configuration, since the wire holding assembly 30 is prevented from being inclined in an unlocking direction (direction in which the wall portion 36 is separated from the outer surface of the housing 10) of the locks 23, 44 by the contact of the inclination preventing portion 47 with the outer surface of the housing 10, vibration resistance can be enhanced. This can prevent the wear of contacts of the terminal fittings T and the mating terminal fittings 51 and disconnection due to the vibration of the wires W.

Further, the inclination preventing portion 47 includes the backlash preventing protrusions 49 configured to come into contact with the outer surface of the housing 10. Accordingly, the backlash of the wire holding assembly 30 can be prevented.

The invention is not limited to the above described and illustrated embodiment. For example, the following embodiments also are included in the scope of the invention.

Although two cavities 11 are provided in the housing 10 in the above embodiment, there is no limitation to this and the housing 10 may include one, three or more cavities.

Although the specific configuration of the vibration limiting portion 31 is described in the above embodiment, the vibration limiting portion may have any configuration if the vibration of the wire in the cavity can be limited.

Although the specific configurations of the first and second locks 23, 44 are described in the above embodiment, the locks may have any configurations if they are lockable to each other in the front-back direction.

The inclination preventing portion 47 is curved along the lower surface of the housing 10 in the above embodiment. However, the inclination preventing portion may be in the form of a long and narrow flat plate projecting forward from the wall or may be composed of a plurality of such long and narrow flat plates arranged in the width direction.

The inclination preventing portion 47 includes the backlash preventing protrusions 49 configured to contact the outer surface of the housing 10 in the above embodiment. However, the backlash preventing protrusions may not be necessarily provided.

The backlash preventing protrusions 49 are provided on both left and right end parts of the inclination preventing portion 47 in the above embodiment. However, the backlash preventing protrusion may be provided in a widthwise intermediate part of the inclination preventing portion and may contact the lower surfaces of the tubular portions.

### REFERENCE SIGNS

C . . . connector
T . . . terminal fitting
W . . . wire
10 . . . housing
11 . . . cavity
23 . . . first lock
30 . . . wire holding assembly
31 . . . vibration limiting portion
34 . . . pressing portion
36 . . . wall
44 . . . second lock
47 . . . inclination preventing portion
49 . . . backlash preventing protrusion

What is claimed is:

1. A connector (C), comprising:
a housing (10) provided with at least one cavity (11) into which a terminal fitting (T) connected to a wire (W) is to be accommodated in a terminal insertion direction (TID);
a wire holding assembly (30) to be mounted to the housing (10) and including at least one vibration limiting portion (31) configured to limit vibration of the wire (W) in the cavity (11) by at least partly entering the cavity in the terminal insertion direction (TID) and a wall (36) extending substantially along an outer surface of the housing (11);
one or more lock portions (23; 44) provided on the outer surface of the housing (10) and in the wall (36) and lockable to each other in a front-back direction; and
at least one inclination preventing portion (47) projecting forward from the wall (36) and substantially extending along the outer surface of the housing (10).

2. The connector of claim 1, wherein the inclination preventing portion (47) includes at least one backlash preventing protrusion (49) configured to contact the outer surface of the housing (10).

3. The connector of claim 1, further comprising one or more standing walls (33) configured to engage the wire (W) when the wire holding assembly (30) is mounted to the housing (10).

4. The connector of claim 3, further comprising at least one pressing portion provided in a rear end of the wire holding assembly (30) and configured to press the wire (W).

5. The connector of claim 4, wherein the pressing portion (34) is provided between two standing walls (33) and a projecting end of the pressing portion (34) is located below distal ends of the standing walls (33).

6. The connector of claim 5, wherein the pressing portion (34) is substantially has a chevron shape and is configured so that an intermediate part in the front-back direction is highest.

7. The connector of claim 5, wherein a projecting end of the pressing portion (34) is a substantially horizontal flat surface.

8. The connector of claim 1, further comprising a window (42) provided in a rear end part of the wire holding assembly (30) and open in the front-back direction.

9. The connector of claim 1, wherein a rear of one lock (44) defines a locking surface (45) to be locked to the other lock (23) and a front surface of one lock (44) is formed into a guiding surface (46) for guiding a locking operation to the other lock (23).
